(19) United States
(12) Patent Application Publication
(10) Pub. No.: US 2025/0092488 A1
(43) Pub. Date: Mar. 20, 2025

(54) Leaching Method

(71) Applicant: TECHNOLOGICAL RESOURCES PTY. LIMITED, Melbourne (AU)

(72) Inventors: Tendekayi Tapera, Melbourne (AU); Ralph Peter Hackl, Melbourne (AU); Nicola Malysiak, Melbourne (AU)

(21) Appl. No.: 18/292,089

(22) PCT Filed: Jul. 28, 2022
(86) PCT No.: PCT/AU2022/050800

§ 371 Date: Jan. 25, 2024

(30) Foreign Application Priority Data
Jul. 28, 2021 (AU) 2021902315

(51) Int. Cl. C22B 15/00; C22B 1/24; C22B 3/02; C22B 3/04; C22B 3/20; C22B 3/22; C22B 11/00

(52) U.S. Cl. CPC C22B 15/0067; C22B 1/2406; C22B 3/02; C22B 3/04; C22B 3/205; C22B 3/22; C22B 11/04; C22B 15/0006; C22B 15/0086

(57) ABSTRACT

A method of leaching a gold/copper-containing sulfidic mined material that includes two leach stages, with a gold leach stage leaching gold from the material with a gold leach liquor and a copper leach stage leaching copper from the material with a copper leach liquor.

### TECHNICAL FIELD

The invention relates to a method of leaching gold, copper and optionally other valuable metals such as silver from a metal-containing material, including a mined material, including a mined ore and a mined waste material.

The term “mined” material includes mined material that is removed from a mine and transported directly for downstream processing and mined material that is in stockpiles and transported from the stockpiles for downstream processing.

The invention relates particularly, although not exclusively, to leaching gold and copper and optionally other valuable metals such as silver from a mined material in the form of a mined ore.

The term “mined” ore is understood herein to include, but is not limited to, (a) run-of-mine ore and (b) run-of-mine ore that has been subjected to at least primary crushing or similar or further size reduction after the material has been mined and prior to being sorted.

The word “ore” is understood herein to mean a natural rock or sediment that contains one or more valuable minerals, typically containing valuable metals, that can be mined, treated and sold at a profit.

The invention also relates particularly, although not exclusively, to leaching any one or more of (a) a gold/copper-containing ore (which may be in the form of agglomerates of ore fragments), (b) a concentrate of the ore, and (c) tailings of the ore or concentrate produced for example by flotation or other downstream processing of the ore or concentrate.

The invention also relates particularly, although not exclusively, to leaching a gold/copper-containing sulfidic material, such as a gold/copper-containing sulfidic ore, such as a sulfidic ore that contains copper minerals such as chalcopyrite (CuFeS₂) and/or enargite (Cu₃AsS₄). The sulfidic ore may contain other copper minerals. The sulfidic ore also contains gold.

It is noted that the invention also extends to leaching a metal-containing material that has been categorized by a mine operator as being a waste material and therefore “non-economic” to recover metals from using conventional recovery options before the invention was made, i.e. processing options used in commercial mines before the invention was made.

It is also noted that the metal-containing material may include a concentrate of the material, including a concentrate of a mined material, including a concentrate of a mined ore. The term “concentrate” is understood herein to mean the result of increasing the concentration of a target (i.e. desirable) metal or a metal-containing mineral of an input feed.

### BACKGROUND ART

Gold and copper are valuable metals, and economically-viable mining and recovering these metals from a metal-containing material, including a mined material, such as a mined ore is increasingly a complex and multi-faceted technology challenge.

Focusing initially on copper, in the leaching of copper-containing mined material in the form of ores (including copper-containing sulfidic ores such as chalcopyrite and/or enargite or other copper-containing sulfide minerals), the particle size of the ores is typically reduced from run-of-mine size, for example by crushing and grinding operations, to allow processing via heap leaching, vat leaching or other reactor leaching options.

These leaching processes involve the application of an acid and an oxidant to dissolve copper into solution. Copper is subsequently recovered from the acidic solution by a range of recovery options, for example, including solvent extraction and electrowinning (SX/EW), cementation onto more active metals such as iron, hydrogen reduction, and direct electrowinning. The acidic solution is regenerated and recycled to leach more copper from the ores.

Leaching may be assisted by the use of microorganisms.

Generally, leaching may provide lower metal recoveries than other process options for recovering copper from sulfidic ores, such as milling and flotation, that produce copper-containing concentrates that are then smelted to produce copper metal.

It is known that it is difficult to leach more than 20-40 wt. % of the total copper from chalcopyrite by heap leaching.

The low copper recovery from chalcopyrite is often thought to be associated with the formation of a passive film on the surface of the chalcopyrite that may be composed of degradation products from the dissolution reaction.

The applicant has developed technology for leaching copper from copper-containing sulfidic material, such as gold/copper-containing sulfidic ores and waste sulfidic materials.

The applicant's technology is described and claimed in the patent specifications of International applications PCT/AU2016/051024 (WO 2017/070747), PCT/AU2018/050316 (WO 2018/184071), and PCT/AU2019/050383 (WO 2019/213694), and the disclosures in the patent specifications of these applications are incorporated herein by cross-reference.

It is known that gold can be present in copper-containing material, such as gold/copper-containing sulfidic ores and waste sulfidic materials.

These ores are the focus of the invention and are hereinafter referred to as “gold/copper-containing ores”.

There are obvious economic benefits to leaching both gold and copper from such gold/copper-containing ores.

However, there are technical challenges leaching gold and copper from gold/copper-containing ores that make this difficult to do efficiently and cost effectively.

The above description is not an admission of the common general knowledge in Australia or elsewhere.

### SUMMARY OF THE DISCLOSURE

The applicant has identified conditions that make it possible to leach gold from a gold/copper-containing material, such as a gold/copper-containing mined ore, in one stage and copper from a gold/copper-containing material, such as a gold/copper-containing mined ore, in another stage of the method efficiently and cost effectively.

In broad terms, the invention provides a method of leaching a gold/copper-containing material, such as a gold/copper-containing mined ore and a waste material, that includes two separate leach stages, with a gold leach stage leaching gold from the material with a gold leach liquor and a copper leach stage leaching copper from the material with a copper leach liquor.

The gold/copper-containing material may be a mined ore.

The mined ore may be a copper sulfide-containing ore.

The mined ore may be a chalcopyrite ore.

The term “chalcopyrite ore” is understood herein to mean an ore that contains the mineral chalcopyrite. The ore may also contain other copper-containing minerals. The ore may also contain pyrite.

The gold/copper-containing material may be a mined material that is categorised by a mine operator as being a waste material and, for example, is stockpiled at a mine.

The leach conditions may be selected so that there is substantially no copper leached in the gold leach stage.

In the case of gold/copper-containing ores, typically ores that have low acid solubility for copper are preferred for processing in the invention because taking copper into solution in the gold leach step may be a complication for downstream processing of the leach liquor. This is less likely to be an issue where gold is leached first, followed by the copper leach.

It is noted that concentrates of copper-containing ores of interest to the applicant are typically primarily copper sulfide minerals which are not acid soluble (except if they have aged considerably, then surface oxidation will have occurred).

The leach conditions may be selected so that there is substantially no gold leached in the copper leach stage.

The leach conditions may be selected so that there is substantially no copper leached in the gold leach stage and substantially no gold leached in the copper leach stage.

The term “substantially no” in the context of copper is understood herein to mean less than 5% by weight, typically less than 1% by weight, more typically less than 0.5% by weight of the copper in the gold/copper-containing material, such as gold/copper-containing ore, is leached in the gold leach stage.

The term “substantially no” in the context of gold is understood herein to mean less than 5% by weight, typically less than 1% by weight, more typically less than 0.5% by weight of the gold in the gold/copper-containing material, such as gold/copper-containing ore, is leached in the copper leach stage.

Carrying out at least one leach under conditions that leach gold or copper with no substantial leaching of the other metal is advantageous in terms of providing an opportunity for:
(a) allowing the conditions of the leach stage to be optimized for maximising recovery of the leached metal; and
(b) simplifying and optimising downstream recovery of the leached metal from solution from the leach stage.

The gold leach stage may be carried out before the copper leach stage.

The gold leach stage may follow the copper leach stage.

The following description focuses on the use of the above-described method to leach a gold/copper-containing material in the form of a gold/copper-containing mined ore. It is emphasized that the invention also relates to use of the above-described method to leach a gold/copper-containing material in the form of a gold/copper-containing waste material, such as in waste stockpiles.

In this context, the invention provides a method of leaching a gold/copper-containing mined ore that includes two leach stages, with a gold leach stage leaching gold from the ore with a gold leach liquor and a copper heap leach stage leaching copper from the ore with a copper leach liquor.

The mined ore may be a copper sulfide-containing ore.

The method may include:
(a) the gold leach stage comprising leaching gold from the ore with the gold leach liquor and producing a gold-containing solution and a gold-depleted ore; and
(b) the copper leach stage comprising leaching copper from the gold-depleted ore with the copper leach liquor and producing a copper-containing solution.

The method may include the opposite order of leach stages, with:
(a) the copper leach stage comprising leaching copper from the ore with the copper leach liquor and producing a copper-containing solution and a copper-depleted ore; and
(b) the gold leach comprising leaching gold from the copper-depleted ore with the gold leach liquor and producing a gold-containing solution.

The gold leach stage may be a heap leach stage.

The gold leach stage may be carried out on agglomerates of ore fragments.

The copper leach stage may be a heap leach stage.

The copper leach stage may be carried out on agglomerates of ore fragments.

The term “fragment” is understood herein to mean any suitable size of mined or treated (e.g. crushed) material having regard to materials handling and processing capabilities of the apparatus used to carry out the method. It is also noted that the term “fragment” as used herein may be understood by some persons skilled in the art to be better described as “particles”. The intention is to use both terms as synonyms.

The method may include forming a heap of the ore and carrying out the gold leach stage and the copper leach stage successively on the ore in the heap.

Alternatively, the method may include forming a heap of the ore and carrying out the gold leach stage and then forming agglomerates of the gold-depleted ore and forming a heap of the agglomerates and carrying out the copper leach stage on the gold-depleted ore in the agglomerates in the heap.

Alternatively, the method may include forming agglomerates of the ore and forming a heap and carrying out the gold leach stage and the copper leach stage successively on the ore in the agglomerates in the heap.

The method may include a heap washing stage between successive leach stages.

The heap washing stage may provide the following advantages:
(a) recovering any residual gold in the heap or in a leach liquor retained in the heap, and
(b) a dilution effect on constituents in the heap or in the leach liquor retained in the heap that may have a negative impact on the effectiveness of the subsequent leach stage in the heap.

The method may include forming agglomerates of the ore, forming a heap of the agglomerates, and carrying out the copper leach stage and the gold leach stage successively on the ore in the agglomerates in the heap.

Alternatively, the method may include forming a heap of the ore and carrying out the copper leach stage and then forming agglomerates of the copper-depleted ore and forming a heap of the agglomerates and carrying out the gold leach stage on the copper-depleted ore in the agglomerates in the heap.

Alternatively, the method may include forming a heap of the ore and carrying out the copper leach stage and the gold leach stage successively on the ore in the heap.

The method may include a heap washing stage between successive leach stages.

The heap washing stage may provide the following advantages:
(a) recovering any residual copper in the heap or in a leach liquor retained in the heap, and
(b) a dilution effect on constituents in the heap or in the leach liquor retained in the heap that may have a negative impact on the effectiveness of the subsequent leach stage in the heap.

It is noted that the invention is not confined to heap leaching the ore.

One of a number of other options is vat leaching the ore. Another option is dump leaching the ore. Another option is stirred tank leaching the ore.

Typically, the gold leach stage is carried out under acidic conditions.

Typically, the gold leach stage and the copper leach stage are carried out under acidic conditions. In practical terms, it would be difficult to convert to basic conditions in one leach after a preceding leach is carried out under acidic conditions, and vice versa.

The gold leach stage may be a thiourea-based leach carried out under acidic conditions.

The gold leach stage may be a thiourea-based leach in which thiourea (CS(NH₂)₂ acts as a complexing/extracting agent for gold that facilitates leaching gold from the ore.

The invention is not confined to a thiourea-based leach and extends to any suitable leach conditions to optimize leaching gold preferentially to leaching copper. Other options include, by way of example, bromide/bromine (or halides in general), thiocyanate (SCN—), and ethylene thiourea.

The gold leach stage may include controlling the concentrations of oxidants, such as ferric, peroxide, and permanganate in the leach liquor.

The gold leach stage may include controlling the ferric concentration in the leach liquor so as not to leach copper.

For example, in some embodiments, the gold leach stage may include controlling the ferric concentration to be from 0 to 5 g/L in the leach liquor.

The selection of the ferric concentration in the leach liquor is important in terms of the impact of ferric on leach conditions. For example, if the ferric concentration is too high, this may have an impact on controlling the oxidation potential of the leach liquor to be a target potential of say 440 mV. Also, if the iron concentration is too high, it can start oxidising the ore (as a side reaction) which could have the unintended leaching of other elements such as Cu.

The gold leach stage may be carried out under ambient temperature conditions.

The gold leach stage may include controlling the heap temperature to be at least 5° C., typically at least 10° C., and more typically at least 20° C.

The gold leach stage may include controlling the heap temperature to be less than 50° C., typically less than 40° C., and more typically less than 30° C.

The gold leach stage may include controlling the pH of the leach liquor to be in a range of pH 1-4.

The gold leach stage may include controlling the pH of the leach liquor to be in a range of pH 1-3.

It is noted that if the pH becomes too high in the case of a thiourea-based gold leach stage (a), any ferric present for partial oxidation of thiourea will start precipitating from solution.

The gold leach stage may include controlling the Eh of the leach liquor to be in a range of 350-550 mV, typically 400-500 mV.

The gold leach stage may be carried out for any suitable time period having regard to factors such as gold concentration and capital and operating costs for the type of leach. In the case of a typical heap leach, the leach time is at least 1 month.

Options other than a thiourea-based leach include a thiocyanate leach at a pH ranging from 0.75 to 3.5, typically at a pH ranging from 1.0 to 3, more typically at a pH ranging from 1.5 to 2.5, even more typically at a pH of about 2.0. The thiocyanate leach may be performed at an Eh in a range of 600-700 mV. Other options include halides: bromides, iodides and chlorides.

The method may include selecting mining and leaching operating conditions such as, but not limited to, ore crush size, options for adding leach reagents, concentrations of leach reagents, leach temperature, leach duration, ferric ion concentration, pH, and Eh of the leach liquor for the gold leach stage and for the copper leach stage.

The method may include separate recovery stages for recovering gold and copper from the respective gold-containing and copper-containing solutions from the leach stages and producing recovered gold and copper streams and spent gold-containing and copper-containing solutions.

Typically, the process includes separate gold and copper leach stages and separate recovery stages for gold and copper.

In the case of a thiourea-based gold leach stage, the method may include a residual thiourea removal stage of removing thiourea from spent gold-containing solution from the gold recovery stage and using the thiourea-depleted solution in the copper leach stage.

Some methods for recovering gold from a gold/thiourea solution from the gold leach stage include electrochemical, activated carbon adsorption, ion-exchange adsorption, precipitation by metal powders, and reduction by sulfur dioxide gas.

The spent gold-containing and copper-containing solutions from the recovery stages may be regenerated and recycled to the heap as part of the leach liquor.

The copper leach stage may include controlling the heap temperature to be less than 75° C., typically less than 65° C., typically less than 60° C., typically less than 55° C., typically less than 50° C., and more typically less than 45° C.

The copper leach stage may include controlling the heap temperature to be at least 10° C., typically at least 20° C., typically at least 30° C., and more typically at least 40° C.

Typically, the copper leach stage includes controlling the heap temperature to be in a range from 55 and 65° C. to accommodate ambient temperatures in various climates. Currently, an aim heap temperature is 60° C.

The copper leach stage may include controlling the oxidation potential of the leach liquor during an active leaching phase of the step to be less than 700 mV, typically less than 660 mV, typically 600-660 mV, more typically in a range of 630-660 mV, all potentials being with respect to the standard hydrogen electrode. It is noted that the oxidation potential will change during the leaching step and is likely to be higher when much of the copper has been leached and the reference to “active leaching phase” is intended to acknowledge this potential change.

Typically, the copper leach stage is carried out under acidic conditions

The copper leach stage may include controlling the pH of the leach liquor to be less than 3.2, typically less than 3.0, typically less than 2.0, typically less than 1.8, typically less than 1.5, typically less than 1.2, and typically less than 1.0.

The copper leach stage may include controlling the pH of the leach liquor to be greater than 0.3, typically greater than 0.5, and typically greater than 1.

Typically, the copper leach stage includes controlling the pH of the leach liquor to be between 0 and 2, more typically between 1 and 1.4, preferably at pH 1.2.

In any given situation, an optimum pH range will depend on a range of factors, including mineralogy, heap temperature, leach composition, etc.

The copper leach stage may include any suitable leach time.

The copper leach stage may include providing silver in a form and within a defined concentration range that successfully catalyses leaching copper from the ore.

The above-mentioned PCT/AU2016/051024 (WO 2017/070747) discloses the addition of silver.

The copper leach stage may include providing silver in a concentration of less than 2 g Ag/kg Cu to catalyse leaching copper.

Typically, the silver concentration is less than 1.5 g Ag/kg Cu.

More typically, the silver concentration is less than 1 g Ag/kg Cu.

Even more typically, the silver concentration is less than 0.5 g Ag/kg Cu.

Yet even more typically, the silver concentration is less than 0.4 g Ag/kg Cu.

There may be situations in which the gold/copper-containing ore has naturally occurring silver.

Naturally-occurring silver in gold/copper-containing ores may have catalyst properties for copper leaching. Naturally-occurring silver may be in one or more of a number of forms in gold/copper-containing ores, including but not limited to native silver, argentite (Ag₂S), chlorargyrite (AgCl), as inclusions of naturally occurring silver in copper minerals and pyrite, and as silver sulfosalts such as tetrahedrite (Cu,Fe,Zn,Ag₁₂Sb₄S₁₃), pyragyrite (Ag₃SbS₃) and proustite (Ag₃AsS₃).

Where there is naturally-occurring silver that has catalyst properties for copper leaching, an operator may take this into account and select a lower concentration of added silver than would otherwise be the case.

By way of example, it may not be necessary to add any silver.

The method may include:
(a) forming agglomerates of fragments of ores and silver; and
(b) leaching the agglomerates, for example in a heap of the agglomerates, with the leach liquor in the copper leach stage.

The agglomeration step (a) may include forming agglomerates by mixing together ore fragments and silver in the agglomeration step.

The agglomeration step (a) may include forming agglomerates by adding silver to ore fragments and then mixing together ore fragments in an agglomeration step.

The agglomeration step (a) may include forming agglomerates of ore fragments in an agglomeration step and then adding silver to the agglomerates.

The agglomerates formed in the agglomeration step (a) may have a low total silver concentration.

As noted above, the fragments in the agglomerates may already have a naturally-occurring low silver concentration before the addition of silver in the agglomeration step (a) and some or all of the naturally occurring silver may have catalyst properties for copper leaching. In practice, this is a factor to take into account when determining the amount of silver to add during the agglomeration step (a) so that the overall active silver concentration remains within a required concentration range. To distinguish between naturally-occurring silver concentrations in ores, such as chalcopyrite ores, and the silver added during the agglomeration step, the added silver is hereinafter referred to as “added silver” or similar terminology.

The added silver and the total silver concentration in the agglomerates are expressed herein in terms of g silver per kg copper in the ore in the agglomerates. The required concentration of added silver in the agglomeration step to achieve a selected agglomerate silver concentration (naturally-occurring and added) can readily be determined by the skilled person. In addition, it is acknowledged that there are different measures of silver concentration in the patent and non-patent literature and it can be challenging to make comparisons of the different ranges disclosed in the literature.

The added silver concentration in the agglomerates may be less than 2 g silver per kg copper in the ore in the agglomerates, typically less than 1.5 g silver per kg copper in the ore in the agglomerates, more typically less than 1 g silver per kg copper in the ore in the agglomerates, more typically again less than 0.5 g silver per kg copper in the ore in the agglomerates, and even more typically less than 0.4 g silver per kg copper in the ore in the agglomerates.

The agglomeration step (a) may include adding silver to the ore fragments by any suitable means and in any suitable form.

The added silver may be in a solid form. For example, the added silver may be present in a pyrite concentrate that is added to the ore in the agglomeration step.

The added silver may be in a solution.

The added silver may be in a solid form that becomes mobile upon dissolution with the leach liquor. It may precipitate or otherwise be deposited on the ore surface.

Typically, the added silver is added to the ore fragments while the fragments are being mixed together.

The agglomeration step (a) may include dispersing added silver on surfaces of particles of copper-containing minerals in ore fragments.

The agglomeration step (a) may include dispersing added silver within the ore fragments.

The agglomeration step (a) may include adding silver to the ore fragments in the form of an aerosol, where the term “aerosol” is understood to mean a colloidal suspension of particles, typically in powder form, in air or gas.

The agglomeration step (a) may include adding silver in solution to the ore fragments in the form of a mist or a spray, where the terms “mist” and “spray” are understood to mean small droplets of silver solution suspended in air.

The selection of a mist/spray/aerosol as a medium for adding the silver solution to the ore fragments makes it possible to maximise the delivery of a small concentration of the silver to a substantially larger mass (and large surface area) of ore fragments. The mist/spray/aerosol approach makes it possible to deliver the silver to a substantial proportion of the ore fragments.

Typically, the agglomeration step (a) may include adding silver to ore fragments in the form of a mist or a spray or aerosol while ore fragments are being mixed.

Typically, the agglomeration step (a) includes using a small concentration of silver compared to the amount of copper-containing ore fragments.

The agglomeration step (a) may include forming agglomerates by also mixing together an acid, typically sulfuric acid, with the ore fragments and the silver. The acid may be added at the same time as, or prior to, or after the silver solution. The added acid concentration may be less than 50 kg H₂SO₄/dry t ore, typically less than 30 kg H₂SO₄/dry t ore and may be less than 10 kg H₂SO₄/dry t ore or less than 5 kg H₂SO₄/dry t ore. Typically, the acid concentration is 0.5-10 kg H₂SO₄/dry t ore.

The agglomeration step (a) may include forming agglomerates by also mixing microorganisms that can assist leaching of copper with the ore fragments and the silver. The microorganisms may be added at the same time as, or prior to, or after the silver solution. The microorganisms may be one or more than one of mesophilic or thermophilic (moderate or extreme) bacteria or archaea. The microorganisms may be bacteria or archaea. The microorganisms may be mesophilic or thermophilic acidophiles.

The agglomeration step (a) may include simultaneously mixing and agglomerating fragments.

The agglomeration step (a) may include mixing fragments in one step and then agglomerating the mixed fragments in a subsequent step. There may be overlap between the mixing and agglomeration steps.

The fragments of the ore may include fractures to facilitate dispersing silver solution with the fragments.

The added silver may be in an aqueous solution.

The added silver may be in a soluble form such as silver nitrate.

The added silver may be in an insoluble form or sparingly soluble form such as silver sulfate or silver chloride or silver sulfide. The term “sparingly soluble” is understood herein to mean salts with solubility less than 0.01 moles/litre.

The added silver may be present in a pyrite concentrate that is added to the ore in the agglomeration step.

The copper leach stage may include providing additives other than silver, such as additives described in the above-mentioned PCT/AU2019/050383 (WO 2019/213694), for the copper leaching stage.

PCT/AU2019/050383 (WO 2019/213694) is based on a realisation that leaching copper-containing ores or concentrates of the ores or tailings of the ores or concentrates can be enhanced via the formation of a complex between (a) sulfur, that has originated from copper minerals in the ores, and (b) an additive that results in an increase in dissolution rates.

By way of example, the sulfur may be in a passivating layer on copper minerals, and the complex may be a complex of the additive and sulfur in the passivating layer that breaks down the passivating layer or reduces the formation of the layer and therefore allows greater access for leaching copper from copper minerals.

PCT/AU2019/050383 (WO 2019/213694) discloses a particular group of nitrogen-containing complexing agents that are effective additives, including a compound that contains the following molecular scaffold or a polymer that contains the molecular scaffold repeated through the polymer:

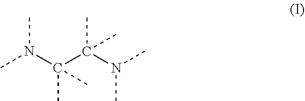

wherein,
the two nitrogen atoms are each independently substituted or unsubstituted, each nitrogen atom is selected from the group consisting of a primary amine group, a secondary amine group, a tertiary amine group,
the carbon atoms may each be substituted or unsubstituted;
the bonds between the nitrogen atoms and carbon atoms in the scaffold may be single bonds or multiple bonds; and
the bonds between the two carbon atoms in the scaffold may be single bonds or multiple bonds.

The concentration of the nitrogen-containing complexing agent additive may be up to 10 g/L, typically up to 5 g/L, typically up to 2.5 g/L, typically up to 1.5 g/L, typically up to 1.25 g/L, and more typically up to 1 g/L, in the leach liquor.

The method may include adding the nitrogen-containing complexing agent additive to the leach liquor continuously or periodically during the method to maintain a required concentration during the method.

The method of addition may be to ores prior to leaching.

The method for addition may be to agglomerates of ore fragments prior to leaching.

For example, the additive may be added while forming agglomerates of ore fragments.

The copper leach stage (b) may include supplying a leach liquor to a heap of agglomerates from agglomeration step (a) and allowing the leach liquor to flow through the heap and leach copper from agglomerates and collecting leach liquor from the heap, processing the leach liquor and recovering copper from the liquor.

The leach liquor may include microorganisms to assist leaching of copper.

The microorganisms may be one or more than one of mesophilic or thermophilic (moderate or extreme) bacteria or archaea. The microorganisms may be bacteria or archaea. The microorganisms may be mesophilic or thermophilic acidophiles.

The copper leach stage may include conducting the leach stage with the leach liquor in the presence of silver and an activation agent that activates silver such that the silver enhances copper leaching.

The activation agent may be any suitable reagent that can activate silver such that the silver enhances copper extraction.

The activation agent may be any one or more than one of silver-complexing ligands such as chlorides, iodides, bromides, and thiourea.

The activation agent may be present in the method by being sprayed or otherwise distributed in a liquid or solid form onto ore fragments or ore concentrates, including before, during or after agglomeration if agglomeration is practiced, or as a component of the leach liquor.

When the activation agent is present in the method as a component of the leach liquor, the method may include providing a selected concentration or concentration range of the activation agent in the leach liquor.

The selected concentration or concentration range of the activation agent in the leach liquor may be the result of any one or more of the following positive steps:
(a) addition of the activation agent to the leach liquor;
(b) removal of the activation agent from the leach liquor;
(c) addition of the activation agent in an agglomeration step;
(d) mixing different ore types having regard to the soluble activation agent in the ores;
(e) selection and blending/mixing of water source/type with regard to activation agent concentration (e.g. use of seawater) in the ores;
(f) other human-intervention into one or more inputs to the leach process that can affect the soluble activation agent concentrations in the leach process.

The selected concentration or concentration range of the activation agent may be different to the background concentrations of the activation agent in the leach liquor, the ore or concentrate. The invention requires an assessment to be made of the required concentration or concentration range of the activation agent for a given ore or concentrate and to assess the available water source(s) and relevant conditions and control the process, for example having regard to steps (a) to (e) above, so that there is the required concentration or concentration range of the activation agent.

The method may include monitoring the concentration of any one or more than one silver-complexing ligands such as chlorides, iodides, bromides, and thiourea.

The copper leach stage may be carried out in the presence of a low concentration or concentration range of the activation agent selected from any one or more than one silver-complexing ligands such as chlorides, iodides, bromides, and thiourea.

The meaning of the term “low concentration” in relation to chlorides, iodides, bromides, thiourea and other silver-complexing ligands will depend in any given situation on a number of factors including mineralogy of the ore, physical characteristics of ore fragments such as the fragment size and particle size distribution, characteristics of agglomerates such as size and porosity, copper concentration in the ore, silver concentration (naturally occurring in ore fragments and added as part of agglomerates), composition of the leach liquor and, in the case of heap leaching, the characteristics of the heap including heap porosity.

The low concentration of chlorides may be up to 5 g/L, typically up to 4 g/L, typically up to 2.5 g/L, typically up to 1.5 g/L, typically up to 1.25 g/L chlorides, and more typically up to 1 g/L chlorides, in the leach liquor.

The low concentration of chlorides may be greater than 0.2 g/L, typically greater than 0.5 g/L, and more typically greater than 0.8 g/L.

The low concentration of iodides and bromides may be the same as for chlorides.

The low concentration of thiourea may be less than 10 g/L in the leach liquor.

Typically, it is not necessary for the leach liquor to contain thiosulfates or other additives to inhibit the precipitation of silver chlorides, iodides or bromides.

The method may include reducing the size of the mined ore prior to the leach stages.

By way of example, the method may include crushing the mined ore prior to the leach stages. The mined ore may be crushed using any suitable means.

The method may include crushing the mined ore in a primary crushing step prior to the leach stages.

The term “primary crushing” is understood herein to mean crushing ore to a top size of 250 to 150 mm in the case of copper-containing ores where the copper is in the form of sulfides. It is noted that the top size may be different for ores containing different valuable metals.

The method may include crushing mined ore in a primary crushing step and then a secondary and possibly tertiary and possibly quaternary crushing step prior to the agglomeration step (a).

The invention also provides a leaching operation for leaching a gold/copper-containing material that comprises:
(a) a gold leach unit operation for leaching gold from the material with a gold leach liquor and producing a gold-containing solution and for recovering gold from the solution;
(b) a copper leach unit operation for leaching copper from the material with a copper leach liquor and producing a copper-containing solution and for recovering copper from the solution.

The mined material may be a copper sulfide-containing ore.

The invention also provides a heap leaching operation for leaching a gold/copper-containing material that comprises:
(a) a heap of a mined material and/or agglomerated fragments of the mined material;
(b) a leach liquor supply unit for supplying to the heap a gold leach liquor for carrying out a gold leach stage on the material in the heap;
(c) a leach liquor supply unit for supplying to the heap a copper leach liquor for carrying out a copper leach stage on the material in the heap either before or after the gold leach stage;
(d) a gold recovery unit for recovering gold from a gold-containing solution discharged from the heap during the course of the gold leach stage and producing a recovered gold stream and a spent gold-containing solution; and
(e) a copper recovery unit for recovering copper from a copper-containing solution discharged from the heap during the course of the copper leach stage and producing a recovered copper stream and a spent copper-containing solution.

The heap leaching operation may include a regeneration unit for regenerating the spent gold-containing solution.

The heap leaching operation may include a regeneration unit for regenerating the spent copper-containing solution.

The heap may include a plurality of lifts.

The mined material may be a gold/copper sulfide-containing ore.

The mined material may be a gold/copper sulfide-containing waste material.

### BRIEF DESCRIPTION OF THE DRAWING

The invention is described further below by way of example only with reference to the accompanying Figures, of which:

FIG. 1 is a flow sheet of one embodiment of a method of leaching gold and copper from a mined material in accordance with the invention;

FIG. 2 is a flow sheet of one embodiment of a method of leaching gold and copper from a mined material in accordance with the invention;

FIG. 3 is a flow sheet of one embodiment of a method of leaching gold and copper from a mined material in accordance with the invention;

FIG. 4 is a graph of gold extraction versus time in Example 1 of the method the invention;

FIG. 5 is a graph of copper extraction versus time in Examples 2-4 of the method the invention;

FIG. 6 is a graph of copper extraction versus time in Examples 5-7 of the method the invention;

FIG. 7 is a graph of gold extraction versus time in Example 8 of the method the invention; and

FIG. 8 is a graph of copper extraction versus time in Example 8 of the method the invention.

### DESCRIPTION OF EMBODIMENTS

The invention makes it possible to to leach gold from a gold/copper-containing material, such as a gold/copper-containing mined ore, in one stage and copper from a gold/copper-containing material, such as a gold/copper-containing mined ore, in another stage of the method efficiently and cost effectively.

Some copper deposits contain significant gold. However, the gold grades of such deposits may not be high enough to deploy the traditional gold leaching process of using cyanide. Even if cyanide is used to extract the gold, the residue would require expensive neutralisation processes to make it suitable to safely extract copper by acid leaching.

Embodiments of the invention use mild conditions to recover the gold followed by copper extraction without the need for intermediate neutralisation of the residue. An additional benefit is that the reagent used for gold leaching may also be beneficial for copper leaching. The term “mild conditions” includes by way of example a thiourea-based leach carried out at ambient temperature (25° C.).

Experiments have indicated that it is possible to leach up to 60% of the gold into solution under mild conditions, such as a thiourea-based leach carried out at ambient temperature (25° C.).

These experiments have also shown that the copper will remain in the ore, providing an opportunity to recover the copper in a subsequent leaching step. This feature of no co-extraction of other unwanted elements in each leach stage is an important feature.

The invention allows gold contained in some copper deposits to be extracted into solution. The recovery of the gold adds value to copper leaching operations using technology such as the applicant's technology that is described and claimed in the patent specifications of the above-mentioned International applications PCT/AU2016/051024 (WO 2017/070747), PCT/AU2018/050316 (WO 2018/184071), and PCT/AU2019/050383 (WO 2019/213694).

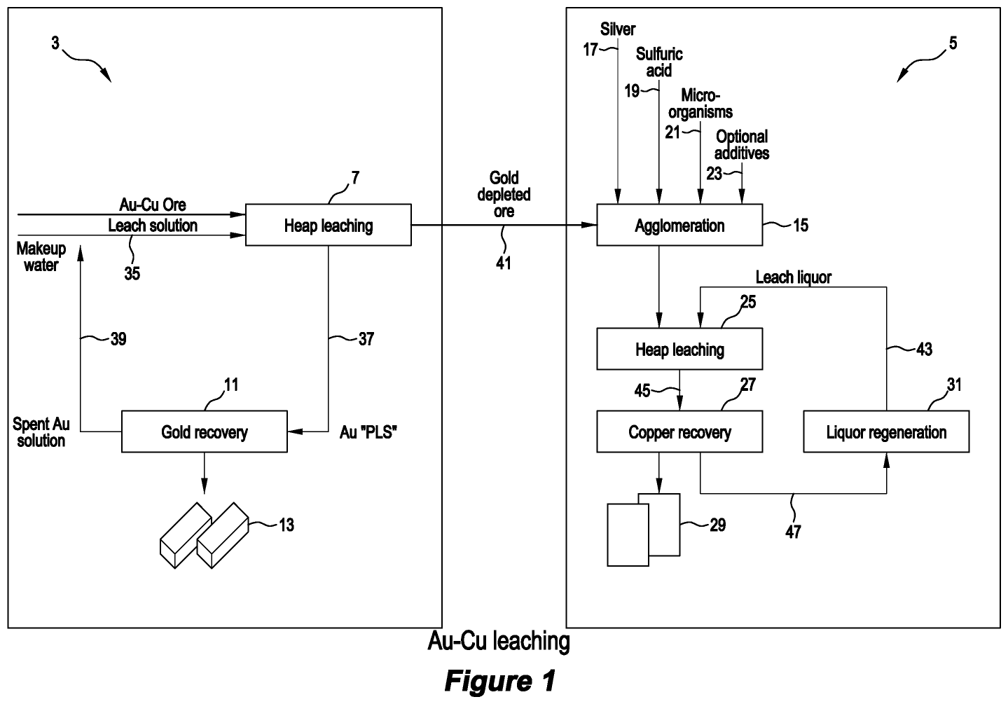

FIGS. 1 to 3 are flow sheets of three embodiments of the method of leaching gold and copper from a gold/copper-containing ore in accordance with the invention. These are not the only embodiments of the invention.

### FIG. 1 Flow Sheet

The FIG. 1 flow sheet includes:
(a) a gold leach operation in the left-hand box in the Figure and generally identified by the numeral 3; and
(b) a copper leach operation in the right-hand box in the Figure and generally identified by the numeral 5.

With reference to the Figure, a gold/copper-containing mined material, in this embodiment crushed and milled fragments of an ore, are formed into a heap and a leach liquor 35 is supplied to an upper surface of the heap and allowed to percolate through the heap in a heap leach stage 7.

Gold is leached from the gold/copper-containing mined ore and taken into solution in the leach stage 7.

At the end of the gold heap leach stage 7, gold-depleted ore 41 is transferred to and processed in the copper leach operation 5, as described further below. The end of the gold leach stage 7 may be determined by a leach time or the remaining gold being a threshold concentration or any other suitable factor.

The gold-containing solution 37 (referred to as a “Au “PLS” in the Figure”) that is discharged from the leach stage 7 is transferred to a gold recovery stage 11.

Gold is recovered from the gold-containing solution 37 in the gold recovery stage 11 and is discharged and processed further to produce a gold product 13.

A spent solution 39 is discharged from the gold recovery stage 11 and is transferred to and becomes part of the feed leach liquor to the leach stage 7.

The gold leach stage 7 may be any suitable stage other than a heap leach, such as leaching in a stirred vat/tank of other suitable vessel.

In the embodiment shown in FIG. 1, the gold leach stage 7 is a thiourea-based leach carried out at ambient temperature (25° C.), with the leach liquor supplied to the stage having a pH of 1.5, a thiourea concentration of 5 g/L and an iron concentration of 0.3 g/L.

In any given situations, the heap leach time will be dependent on a range of factors but typically will be at least days and may be up to several months.

It is noted that the pH, thiourea concentration, and iron concentration mentioned above were the conditions for a stirred reactor test conducted on minus 2 mm particles at ambient temperature.

It is also noted that ambient temperature will vary considerably depending on location and season and that, as long as the temperature within the heap is above freezing point, the gold will leach, but more slowly than if the heap temperature was 20° C. or 25° C. Thiourea leaching typically generates very little heat.

In the copper leach operation 5, the gold-depleted ore 41 is transferred to an agglomeration unit 15 and agglomerated with the following feed materials:
(b) silver 17, in this embodiment as a silver solution (but could be in a solid form), typically at an added concentration of silver of less than 5 g silver per kg copper in the ore in the agglomerates;
(c) sulfuric acid 19 in any suitable concentration;
(d) microorganisms 21 of any suitable type and in any suitable concentration; and
(e) an activation agent 23, such as silver-complexing ligands including chlorides, iodides, bromides, and thiourea.

The agglomeration unit 15 may be any suitable construction that includes a drum, conveyor (or other device) for mixing the feed materials for the agglomerates and agglomerating the feed materials. Mixing and agglomerating the feed materials for the agglomerates may occur simultaneously. Alternatively, mixing the feed materials may be carried out first and agglomerating (for example initiated by the addition of the acid) may be carried out after mixing has been completed to a required extent. Moreover, the timing of adding and then mixing and agglomerating feed materials may be selected to meet the end-use requirements for the agglomerates. For example, it may be preferable in some situations to start mixing fragments of ores and then adding silver in a solution or in a solid form of silver, acid, and microorganisms progressively in that order at different start and finish times in the agglomeration step. By way of particular example, it may be preferable in some situations to start mixing fragments of ores and then adding silver in a solution or in a solid form and acid together, and then adding microorganisms at different start and finish times in the agglomeration step.

The applicant has found that adding silver as a solution in a fine mist or spray or as solid particles in an aerosol to fragments of ores as the ore fragments are being mixed in a suitable mixer, such as a drum mixer, is a particularly suitable way of achieving a desirable dispersion of silver on the ore fragments.

It is noted that the above-mentioned patent specifications of International applications PCT/AU2016/051024 (WO 2017/070747), PCT/AU2018/050316 (WO 2018/184071), and PCT/AU2019/050383 (WO 2019/213694) in the name of the applicant provide information on suitable agglomeration conditions and the use of additives in addition to silver and on other stages in the copper leach operation 5.

The agglomerates produced in the agglomeration unit 15 are subsequently used in the construction of a heap 25.

Subsequently, copper is leached from the gold-depleted ore in the agglomerates in the heap 25 via the supply of a suitable leach liquor 43 to the heap. The copper leach stage operates for any suitable time. Typically, the copper leach stage operates for at least several months.

The heap 25 may be any suitable heap.

By way of example, the heap may be of the type described in the patent specification of International application PCT/AU2011/001144 (WO2012/031317) in the name of the applicant, and the disclosure of the heap construction and leaching process for the heap in the International publication is incorporated herein by cross-reference

The agglomerates produced in the agglomeration unit 15 may be transferred directly to a heap construction site. Alternatively, the agglomerates may be stockpiled and used as required for a heap. The agglomeration unit 15 and the heap 25 may be in close proximity. However, equally, the agglomeration unit 15 and the heap 25 may not be in close proximity.

A copper-containing solution 45 is discharged from the heap 25 and is transferred to a copper recovery unit 27.

Copper is recovered from the copper-containing solution 45 and is processed to form a copper product 29 in a downstream processing unit.

A spent copper solution 47 is discharged from the copper recovery unit 27 and is transferred to a regeneration unit 31 and is regenerated and produces the leach liquor 43 that is recycled to the heap 25. Make-up leach liquor may be added, as required.

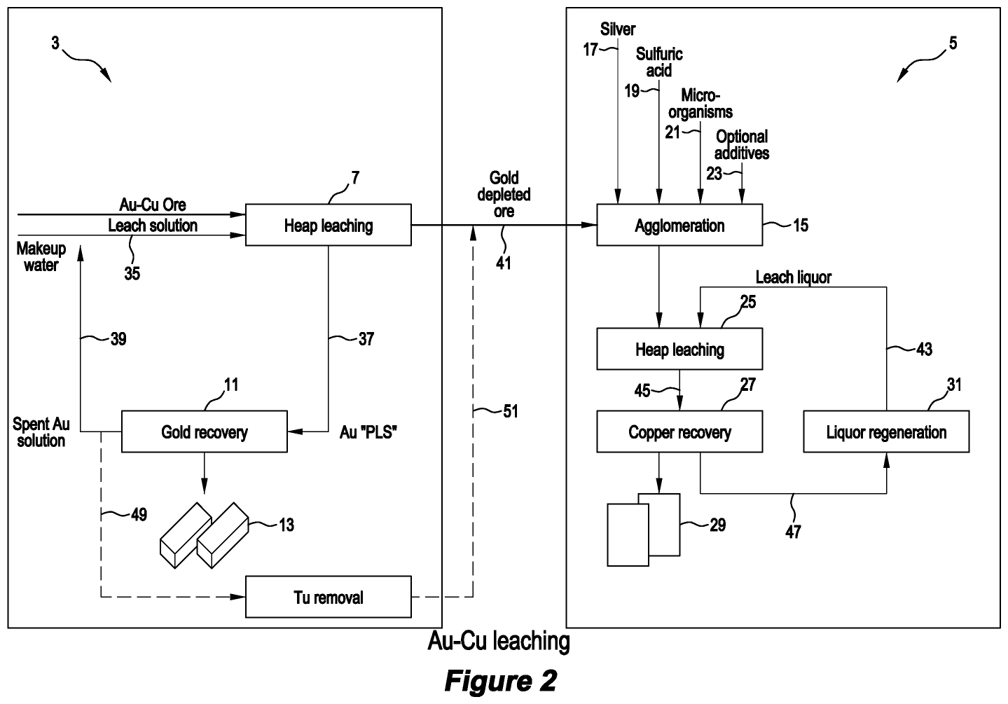

### FIG. 2 Flow Sheet

The FIG. 2 flow sheet includes:
(a) a gold leach operation generally identified by the numeral 3; and
(b) a copper leach operation generally identified by the numeral 5.

The FIG. 2 flow sheet includes all of the unit operations of the FIG. 1 flow sheet and the same reference numerals are used to describe the same features.

The FIG. 2 flow sheet also includes transferring a part 49 of the spent gold solution 39 to a thiourea removal stage 31 and removing thiourea from the solution and transferring the thiourea-depleted solution 51 to the gold-depleted ore stream 41 being transferred from the solid/liquid unit 9 to the copper leach operation 5.

The thiourea-depleted solution 51 may be required as a makeup solution for the the copper leach operation 5.

One thiourea removal option is activated carbon adsorption, with thiourea subsequently being desorbed from the carbon and reused in the process.

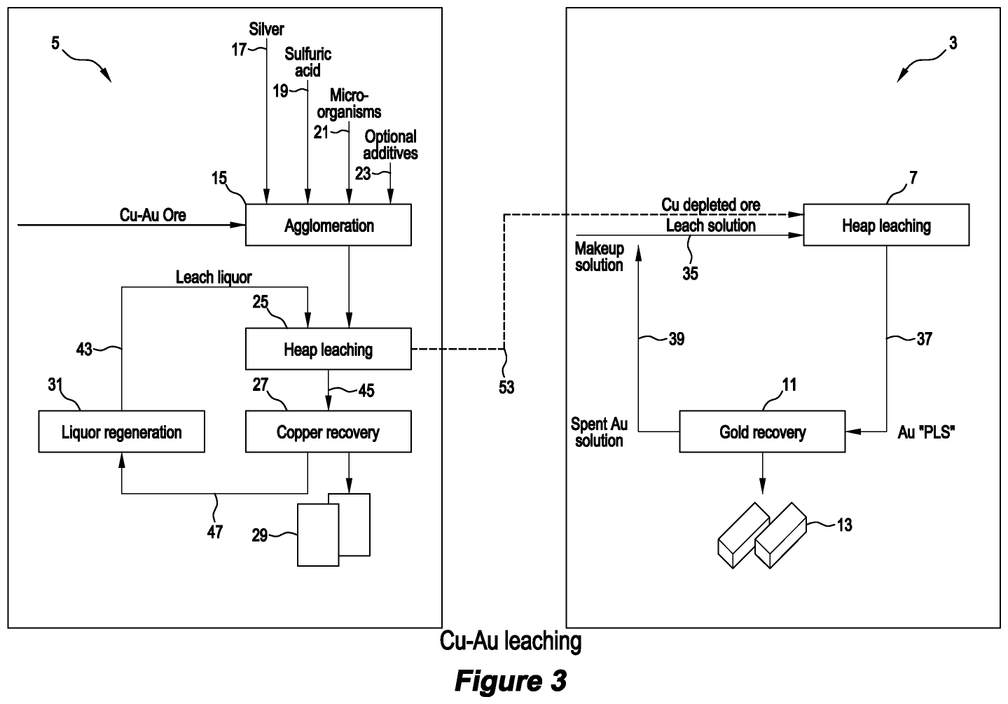

### FIG. 3 Flow Sheet

The FIG. 3 flow sheet is the reverse order to the FIGS. 1 and 2 flowsheets in that the copper leach operation 5 precedes the gold leach operation 3.

The same reference numerals are used to describe the same features.

In this embodiment, at the conclusion of the heap leach stage 25, the gold leach stage 7 of the gold leach operation 3 is carried out on the existing heap.

Specifically, the copper-depleted solids from copper leaching do not physically move (as shown by the broken line 53).

The thiourea-based gold leaching solutions are simply introduced to the heap, with a washing step between the leach stages.

The heap leaching operation may be a multiple lift operation with a new lift added to an existing lift after the copper leach is completed.

### EXAMPLES

### Example 1

Laboratory-scale test work was carried out by the applicant in accordance with the FIG. 1 flow sheet, with a gold leach stage using thiourea, a solid/liquid separation stage, and gold-depleted solids being transferred to be used as a feed material for a copper leach stage, with the copper leach stage being based on above-mentioned patent specifications of applicant's technology described in International applications PCT/AU2016/051024 (WO 2017/070747), PCT/AU2018/050316 (WO 2018/184071), and PCT/AU2019/050383 (WO 2019/213694).

The results of the test work are that:
(a) the gold leach stage achieved about 45.5% gold recovery, i.e. gold extraction from ore, and
(b) no copper being detected in the gold-containing solution from the gold leach stage after 48 hours.

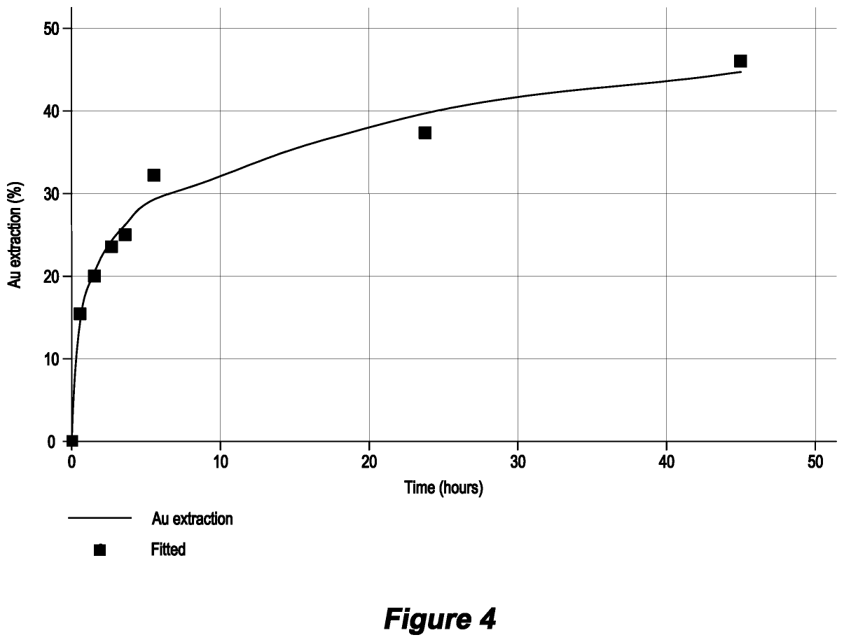

FIG. 4 is a graph of gold extraction versus time in the test work.

The test work results demonstrate the viability of a two-stage heap leach process, as shown in FIGS. 1 and 2, where the gold is first extracted at near-ambient temperature (no bacteria), followed by copper leaching at elevated temperature, using bacteria and under more oxidising conditions than in the gold leach stage.

### Examples 2-8

The following Examples describe leach tests carried out on the following ore samples.

### Ore Samples—Elemental Compositions

| | | Ore | Ore |
|---|---|---|---|
| Element | Unit | Type A | Type B |
| Au | ppm | 1.40 | 1.59 |
| Ag | ppm | 1.90 | 23.00 |
| Al | % | 7.95 | 6.20 |
| As | % | 0.01 | 0.47 |
| Ca | % | 0.73 | 0.15 |
| Cl | ppm | 45.60 | 4.10 |
| Cu | % | 0.97 | 1.29 |
| F | ppm | 1079.8 | 1162.0 |
| Fe | % | 3.71 | 13.43 |
| K | % | 3.70 | 1.18 |
| Mg | % | 1.11 | 0.04 |
| NO₃ | ppm | 19.20 | 1.40 |
| Si | % | 31.20 | 23.03 |

### Ore Samples—Mineral Abundance (Type A Ore)

| | Abundance |
|---|---|
| Mineral | (%) |
| Chalcocite/Digenite | 0.002 |
| Covellite | 0.004 |
| Cu Oxides | 0.014 |
| Chalcopyrite | 2.766 |
| Bornite | 0.024 |
| Enargite | 0.096 |
| Other Cu Minerals | 0.041 |
| Cu Clays | 0.011 |
| Cu-Containing Fe | 0.000 |
| Oxide | |
| Pyrite | 2.822 |
| Sphalerite | 0.028 |
| Sulphur | 0.003 |

### Ore Samples—Mineral Abundance (Type B Ore)

| | Abundance |
|---|---|
| Mineral | (%) |
| Cu Oxides | 0.006 |
| Chalcopyrite | 0.060 |
| Enargite | 2.719 |
| Other Cu Minerals | 0.005 |
| Pyrite | 27.719 |
| Sphalerite | 0.138 |
| Sulphur | 0.083 |

Examples 2-8 are summarised as follows:
Examples 2-4 are for gold leach and then copper leach sequences for Ore Type A.
Examples 5-7 are for copper leach and then gold leach sequences for Ore Type A.
Example 8 is for gold leach and then copper leach sequences for Ore Type B.

### Example 2

### Gold Leaching Step

Example 2 was performed accordance with the FIG. 1 flow sheet.

300 g of Ore type A which had been stage crushed to a −2 mm size was mixed with 700 g of solution with the following composition: 3 g/L ferric sulfate and 5 g/L thiourea at pH 1.5 with air bubbled into a reactor at 1 L/min. The reactor contents were agitated using an overhead impeller and the temperature was maintained at 25° C. in a water bath for the duration of the test. Leaching was maintained for 10 days with liquor sub-samples being collected at pre-set times. After leaching for 10 days, the residue was filtered from the solution. The solid residue was washed sequentially using two 500 mL lots of pH 1.5 solution. This was followed by mixing thoroughly followed by filtration for 10 minutes for each wash step. After the acid wash, the leach residue was washed using 1 L of deionized water for 10 minutes. The slurry was then filtered to produce a washed cake which was then dried at 40° C. until all the moisture was driven off.

### Copper Leaching Step

The residue from the gold leaching step described above was subsequently subjected to a copper leaching step. A 20% slurry density was targeted for the copper leach step. All the recovered residue from the gold leaching step was leached without any prior treatment.

The leach solution had the following composition:

| Species | Unit | Value |
|---|---|---|
| Fe³⁺ | g/L | 13.5 |
| Fe²⁺ | g/L | 2.5 |
| Al³⁺ | g/L | 7.0 |
| Mg²⁺ | g/L | 0.5 |
| Co²⁺ | g/L | 0.5 |
| SO₄²⁻ | g/L | 80 |
| Ag⁺ | g Ag/kg Cu | 0.25 |

The test was maintained at 60° C. using a water bath, with a pH 1.2 target and Eh target of 700 mV. A bacterial inoculum was introduced after running for 30 days. Samples were withdrawn at pre-determined times to track the rate of Cu extraction and analysed for elemental compositions. At the end of the test, the residue was filtered from the solution. The solid residue was washed sequentially using two 500 mL lots of pH 1.2 solution. This was followed by mixing thoroughly followed by filtration for 10 minutes for each wash step. After the acid wash, the leach residue was washed using 1 L of deionized water for 10 minutes. The slurry was then filtered to produce a washed cake which was then dried at 40° C. until all the moisture was driven off.

The final solid residue was analysed for gold and other elements. Gold analysis was done by fire assay which gave any indication of all the gold still present in the residue. The residues were also analysed using cyanide leaching to determine the cyanide soluble gold which was still present in the leach residue.

### Example 3

### Gold Leaching Step

Example 3 was conducted similar to Example 2 on of Ore type A except that the thiourea concentration was reduced to 2.5 g/L. All other steps were similar.

### Copper Leaching Step

The copper leach stage was conducted in a similar way to Example 2.

### Example 4

### Gold Leaching Step

Example 3 was conducted similar to Example 2 on of Ore type A except that the thiourea concentration was reduced to 1.25 g/L. All other steps were similar.

### Copper Leaching Step

The copper leach stage was conducted in a similar way to Example 2.

### Example 5

Example 5 was performed accordance with the FIG. 3 flow sheet.

### Copper Leaching Step

Ore type A was subjected to a bulk copper leaching step. The ore had been crushed to −2 mm size. A 20% slurry density was targeted for the copper leach step. The leach solution had the following composition:

| Species | Unit | Value |
|---|---|---|
| Fe³⁺ | g/L | 13.5 |
| Fe²⁺ | g/L | 2.5 |
| Al³⁺ | g/L | 7.0 |
| Mg²⁺ | g/L | 0.5 |
| Co²⁺ | g/L | 0.5 |
| SO₄²⁻ | g/L | 80 |
| Ag⁺ | g Ag/kg Cu | 0.25 |

The test was maintained at 60° C. using a hot plate, with a pH 1.2 target and Eh target of 700 mV. A bacterial inoculum was introduced after running for 23 days. Samples were withdrawn at pre-determined times to track the rate of Cu extraction. At the end of the leaching period, the residue was separated from the liquor and washed thoroughly with acid solution at pH 1.2. The washed solids were then rinsed using deionized water followed by solid liquid separation. The washed solids were dried at 40° C. The dried solids were blended and representatively split into 300 g fractions for the subsequent gold leaching steps in this Example and in Examples 6 and 7.

### Gold Leaching Step

One portion of the copper leach residue described in the copper leaching step above was mixed with 700 g of solution with the following composition: 3 g/L ferric sulfate and 5 g/L thiourea at pH 1.5 and air was bubbled into the reactor at 1 L/min. The reactor contents were mixed using an overhead impeller and the temperature was maintained at 25° C. in a water bath for the duration of the test. Leaching was maintained for 10 days with liquor sub-samples being collected at pre-set times. After leaching for 10 days, the residue was filtered from the solution. The solid residue was washed sequentially using 500 mL of pH 1.5 water by mixing thoroughly followed by filtration for 10 minutes for each wash step. After the acid wash, the leach residue was washed using 1 L of deionized water for 10 minutes. The slurry was then filtered to produce a washed cake which was then dried at 40° C. until all the moisture was driven off.

### Example 6

Example 6 was performed accordance with the FIG. 3 flow sheet.

### Copper Leaching Step

The copper leach step was conducted as part of the bulk copper leach described in Example 5. A portion of the leach residue was then used for the gold leach step.

### Gold Leaching Step

The residue from the copper leaching step was conducted similar to the gold leaching step for Example 5. However, the thiourea concentration was 2.5 g/L. All other test conditions are as described in example 5.

### Example 7

Example 7 was performed accordance with the FIG. 3 flow sheet.

### Copper Leaching Step

The copper leach step was conducted as part of the bulk copper leach described in Example 5. A portion of the leach residue was then used for the gold leach step.

### Gold Leaching Step

The residue from the copper leaching step was conducted similar to the gold leaching step for Example 5. However, the thiourea concentration was 1.25 g/L. All other test conditions are as described in Example 5.

### Example 8

### Gold Leaching Step

Example 8 was conducted similar to Example 2, except that the ore was on Ore type B that had been pulverized and the leaching duration was also only six days. All other steps were similar, except for one additional washing step before the acid wash step, which included washing with thiourea in pH 1.5 acid solution.

### Copper Leaching Step

100 g of the residue from the gold leaching step was split out and used for the copper leaching step. In this case the slurry density of 10% was targeted. A low sulfate leach solution was used with the following composition:

| Species | Unit | Value |
|---|---|---|
| Fe³⁺ | g/L | 13.5 |
| Fe²⁺ | g/L | 2.5 |
| Al³⁺ | g/L | 7.0 |
| Mg²⁺ | g/L | 0.5 |
| Co²⁺ | g/L | 0.5 |
| SO₄²⁻ | g/L | 80 |
| Ag⁺ | g Ag/kg Cu | 0.25 |

The test was maintained at 60° C. using a hot plate, with a pH 1.2 target. The test was maintained at 60° C. using a jacketed reactor vessel, with a pH 1.2 target and no Eh target. The bacterial inoculum was also introduced at the start of the copper leaching step. As per the other examples, samples were withdrawn at pre-determined times to track the rate of Cu extraction.

### Results

### Ore Type A Tests-Gold Leach First Followed by a Copper Leach

### Gold Leach Results

| | | Percentage |
|---|---|---|
| | | of cyanide |
| | Tu | soluble gold |
| Sample | concentration | extracted |
| Units | g/L | % |
| Example 2 | 5 | 64 |
| Example 3 | 2.5 | 27 |
| Example 4 | 1.25 | 35 |

The gold extraction was calculated as the percentage of soluble gold (i.e., cyanide soluble gold) which was extracted by thiourea leaching.

The gold leaching results show that the greatest Au extraction occurred in the presence of 5 g/L thiourea at 64% (Example 2). At 2.5 g/L (Example 3) and 1.25 g/L (Example 4) thiourea, the gold extractions were 27% and 35% respectively.

### Copper Leach Results

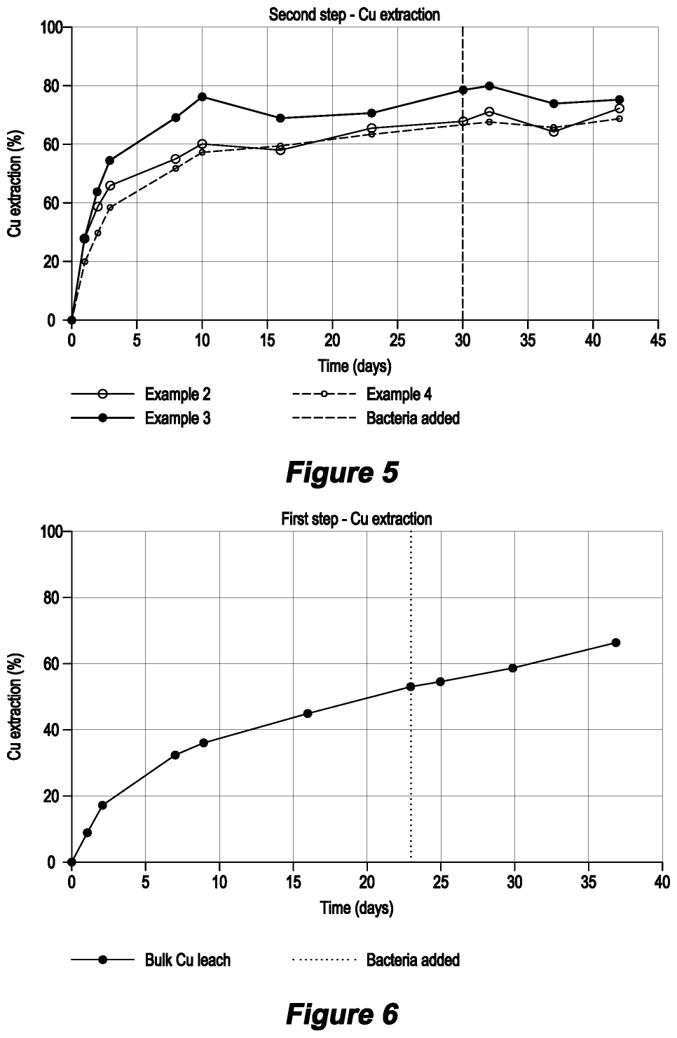

The copper leach results for Examples 2-4 are summarised in FIG. 5.

The FIGURE is a graph of copper extraction versus time.

The graph includes a line at 30 days that indicates that this is when ferrous iron oxidizing and sulfur oxidizing microbes were added to the leach in each Example.

The graph shows that between 65% and 70% of the Cu in the feed was leached in the Cu leaching steps in Examples 2-4 under the conditions tested.

These results show that an Au leaching step before Cu leaching does not prevent Cu extraction and that good Cu extractions can be achieved.

The copper extraction step can be further optimized as previously shown by the applicant in the above-mentioned patent specifications of International applications PCT/AU2016/051024 (WO 2017/070747), PCT/AU2018/050316 (WO 2018/184071), and PCT/AU2019/050383 (WO 2019/213694).

### Ore Type A Tests—Copper Leach First Followed by Gold Leach

### Copper Leach Results

As described for Example 5, 6 and 7, a bulk copper leach was carried out and the bulk leach residue was then used for Au leach tests described in Examples 5-7.

FIG. 6 is a graph of copper extraction versus time.

The graph includes a line at 23 days that indicates that this is when bacteria were added to the leach in each Example.

The graph shows that between 65% of the Cu in the feed was leached in the bulk Cu leach step in 37 days under the conditions tested.

The copper extraction process can be optimized as previously shown by the applicant in the above-mentioned patent specifications of International applications PCT/AU2016/051024 (WO 2017/070747), PCT/AU2018/050316 (WO 2018/184071), and PCT/AU2019/050383 (WO 2019/213694).

### Gold Leach Results

Leaching of residue from the copper leaching steps of Examples 5-7 showed that gold could still be significantly extracted from the residue.

For example, based on leach solution data it was found that the highest extraction was obtained within 48 hours.

The leach results show that that high gold extraction was obtained when the copper is leached out first. This is shown by high gold extraction values for Examples 5, 6 and 7 (see below table) compared to Examples 2, 3 and 4 (see above table).

With reference to the table below, in Example 5 86% of soluble gold was extracted in the presence of 5 g/L thiourea. Similarly, 90% and 73% of the gold was extracted in Example 6 (2.5 g/L thiourea) and Example 7 (1.25 g/L thiourea) respectively.

The high extractions are possibly due to some of the gold being present in the crystal lattices of chalcopyrite and/or pyrite. Such gold is commonly referred to as refractory gold or ‘invisible gold’. When the copper leach step is carried out first, distortions of the chalcopyrite/pyrite crystal lattices occur. This creates vacancies (or pathways) for the gold lixiviant to reach the gold left behind and cause its dissolution. This process is not possible if the chalcopyrite and/or pyrite lattices are still intact. In such a case, typically only a minor portion of the gold is available for leaching, provided that the ore is porous or is ground fine enough to expose the gold to the lixiviant. Importantly, complete destruction of the sulfide minerals hosting the gold is not necessarily required to free up the majority of the gold for subsequent dissolution with the gold lixiviant.

Thorough washing of the copper leaching residue is advisable before leaching that residue. This is because any copper present in the solution will consume the thiourea reagent. The copper will form a copper-thiourea complex which means that less thiourea may be available for the leaching of gold. The applicant has managed to thoroughly wash out the copper to prevent copper interference with gold leaching. It is noted that such thorough washing/rinsing is not really practical in heap leaching; some dissolved copper will always remain in the heap. Therefore, in practice, for heap leaching some rinsing is preferable if practical to do so.

| | | Percentage |
|---|---|---|
| | | of cyanide |
| | Tu | soluble gold |
| Sample | concentration | extracted |
| Units | g/L | % |
| Example 5 | 5 | 86 |
| Example 6 | 2.5 | 90 |
| Example 7 | 1.25 | 73 |

### Ore Type B Tests—Au Leach First Followed by Cu Leach—Example 8

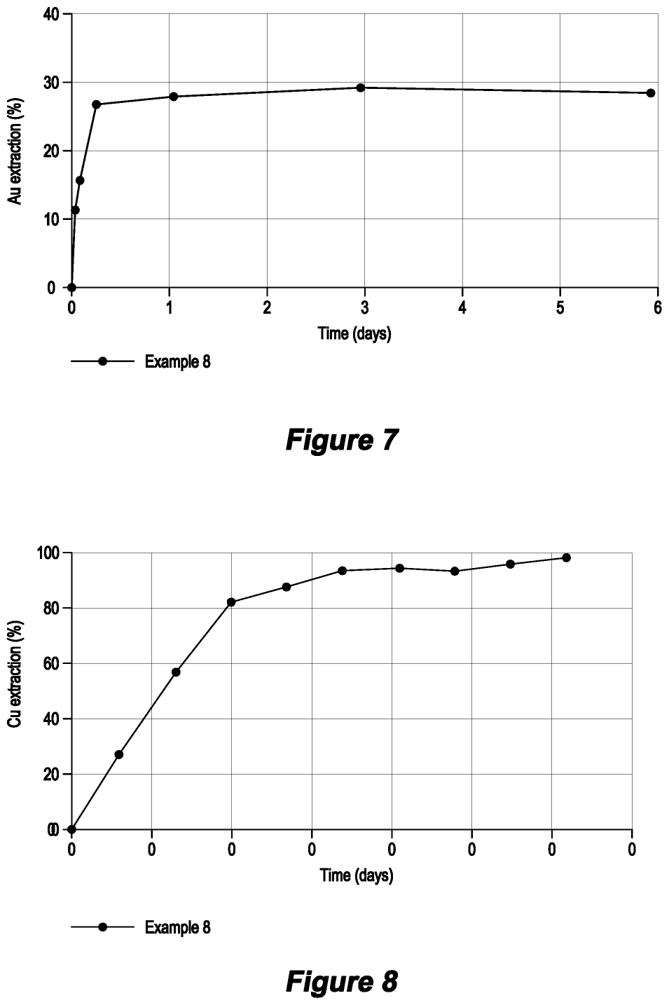

FIG. 7 is a graph of gold extraction versus time for Ore type B in Example 8.

The graph shows that close to 30% of the gold was extracted within 3 days.

The residues from the Au leaching tests were subjected to copper leaching as previously discussed.

FIG. 8 is a graph of copper extraction versus time.

The graph shows that close to 100% of the copper was extracted in 60 days.

These results show that additional value can be extracted from the ore by first leaching gold followed by copper leaching.

The copper leaching step was not impacted by the gold extraction step.

Many modifications may be made to the embodiments of the invention described above without departing from the spirit and scope of the invention.

By way of example, whilst the embodiments described in relation to FIGS. 1 and 2 comprise the gold heap leach operation 3 on ore fragments and then the copper leach operation 5 on agglomerates of a gold-depleted ore 41, the invention is not so limited and extends to forming a single heap of ore fragments or agglomerates of ore fragments and carrying out successive gold leaching and copper leaching stages on the material, with a wash stage between the stages.

By way of example, whilst the embodiments described in relation to FIGS. 1 to 3 relate to a gold/copper-containing ore, the invention is not so limited and extends generally to gold/copper-containing material, including material that has been categorised as waste material.

By way of example, the invention extends to leaching any one or more of a concentrate of a gold/copper-containing ore and tailings of the ore or concentrate produced for example by flotation or other downstream processing of the ore or concentrate.

By way of example, the invention extends to leaching agglomerates of fragments of gold/copper-containing material.

By way of example, whilst the embodiments described in relation to FIGS. 1 to 3 relate to leaching gold and copper, the invention is not so limited and extends to leaching gold, copper and other valuable metals such as silver from a mined material.

By way of example, whilst the embodiments described in relation to FIGS. 1 to 3 and the Examples, include the use of particular additives, the invention is not so limited. For example, if the pyrite concentrate added in agglomeration contains refractory gold (i.e. gold locked up in pyrite and less commonly in any copper sulfide minerals contained in the concentrate), leaching the copper first will also provide a benefit of oxidizing the pyrite and freeing up the gold for subsequent recovery in the gold leaching step.

1. A method of leaching a gold/copper-containing sulfidic mined material that includes two leach stages, with a gold leach stage leaching gold from the material with a gold leach liquor and a copper leach stage leaching copper from the material with a copper leach liquor.

2. The method defined in claim 1 wherein leach conditions are selected so that there is substantially no copper leached in the gold leach stage.

3. The method defined in claim 1 wherein leach conditions are selected so that there is substantially no gold leached in the copper leach stage.

4. (canceled)

5. The method defined in claim 1 wherein the gold leach stage is a heap leach stage.

6. The method defined in claim 1 wherein the copper leach stage is a heap leach stage.

7. The method defined in claim 1 includes separate recovery stages for recovering gold and copper from respective gold-containing and copper-containing solutions from the leach stages and producing recovered gold and copper streams and spent gold-containing and copper-containing solutions.

8. (canceled)

9. (canceled)

10. The method defined in claim 1 wherein the gold/copper-containing material is a mined ore or a mined waste material and the method includes:
(a) the gold leach stage comprising leaching gold from the mined ore or the mined waste material with the gold leach liquor and producing a gold-containing solution and a gold-depleted ore; and
(b) the copper leach stage comprising leaching copper from the gold-depleted ore with the copper leach liquor and producing a copper-containing solution.

11. The method defined in claim 1 wherein the gold/copper-containing material is a mined ore or a mined waste material and the method includes:
(a) the copper leach stage comprising leaching copper from the material with the copper leach liquor and producing a copper-containing solution and a copper-depleted material; and
(b) the gold leach stage comprising leaching gold from the copper-depleted material with the gold leach liquor and producing a gold-containing solution.

12. The method defined in claim 10 includes forming a heap of the material and carrying out the gold leach stage and the copper leach stage successively on the material in the heap.

13. The method defined in claim 11 includes forming a heap of the material and carrying out the copper leach stage and the gold leach stage successively on the material in the heap.

14. The method defined in claim 12 includes a heap washing stage between successive leach stages.

15. (canceled)

16. The method defined in claim 1 includes carrying out the gold leach stage out under acidic conditions.

17. The method defined in claim 1 wherein the gold leach stage is a thiourea-based leach in which thiourea (CS(NH₂) 2) acts as a complexing/extracting agent for gold that facilitates leaching gold from the ore material.

18. The method defined in claim 1 includes controlling the ferric concentration in the gold leach liquor so as not to leach copper in the gold leach stage.

19. (canceled)

20. The method defined in claim 1 includes controlling the Eh of the gold leach liquor to be in a range of 350-550 mV in the gold leach stage.

21. The method defined in claim 1 includes carrying out the copper leach stage under acidic conditions.

22. (canceled)

23. The method defined in claim 1 wherein the copper leach stage includes conducting the leach stage with the leach liquor in the presence of silver as a copper leach catalyst and an activation agent that activates silver such that the silver enhances copper leaching.

24. The method defined in claim 1 includes controlling the heap temperature to be less than 75° C. in the copper leach stage.

25. (canceled)

26. The method defined in claim 1 includes controlling the oxidation potential of the copper leach liquor during an active leaching phase of the copper leach stage to be less than 700 mV.

27. (canceled)

28. (canceled)

29. (canceled)

30. A heap leaching operation for leaching a gold/copper-containing sulfidic mined material that comprises:
(a) a heap of a mined material and/or agglomerated fragments of the mined material;
(b) a leach liquor supply unit for supplying to the heap a gold leach liquor for carrying out a gold leach stage on the material in the heap;
(c) a leach liquor supply unit for supplying to the heap a copper leach liquor for carrying out a copper leach stage on the material in the heap;
(d) a gold recovery unit for recovering gold from a gold-containing solution discharged from the heap during the course of the gold leach stage and producing a recovered gold stream and a spent gold-containing solution; and
(e) a copper recovery unit for recovering copper from a copper-containing solution discharged from the heap during the course of the copper leach stage and producing a recovered copper stream and a spent copper-containing solution.
